(19) United States
(12) Patent Application Publication
(10) Pub. No.: US 2017/0185305 A1
(43) Pub. Date: Jun. 29, 2017

(54) OPTIMIZATION OF DISK SECTOR DUPLICATION IN A HETEROGENEOUS CLOUD SYSTEMS ENVIRONMENT

(71) Applicant: International Business Machines Corporation, Armonk, NY (US)

(72) Inventors: Sasikanth Eda, Vijayawada (IN); Deepak R. Ghuge, Ahmednagar (IN); Sandeep R. Patil, Pune (IN); Sanjay K. Sudam, Pune (IN)

(21) Appl. No.: 14/980,019

(22) Filed: Dec. 28, 2015

(51) Int. Cl. G06F 3/06

(52) U.S. Cl. CPC G06F 3/065; G06F 3/0604; G06F 3/0643; G06F 3/0653; G06F 3/0644; G06F 3/067; G06F 3/0689

(57) ABSTRACT

A method for optimizing duplication of disk sector architecture in a heterogeneous cloud systems environment, is provided. The method includes identifying a file system platform and name space for tracking a plurality of disk, of the disk sector architecture. The method further includes configuring a systems framework, of the identified file system platform, for collecting information of the plurality of disk assigned to the file systems platform. The method further includes equipping the file system platform and a monitoring system with learning or knowledge based engines to identify workload types for utilizing the file system platform and the named space to identify health of multiple platters of the plurality of disk assigned to the file systems platform. The method further includes calculating duplication data of sectors of the plurality of disks of the identified workload types, based on the sectors of disks.

### BACKGROUND

The present invention relates generally to the field of computers, and more particularly to optimization of disk sector duplication in a heterogeneous cloud systems environment. Hard disk drive platter (or disk) is the circular disk on which magnetic data is stored in a hard disk drive. The rigid nature of the platters in a hard drive is what gives them their name. Hard drives typically have several platters which are mounted on the same spindle. A platter can store information on both sides, requiring two heads per platter.

### SUMMARY

According to one embodiment, a method for optimizing duplication of disk sector architecture in a heterogeneous cloud systems environment, is provided. The method includes identifying a file system platform and name space for tracking a plurality of disk, of the disk sector architecture, wherein plurality of disks are assigned to file systems of the file system platform. The method further includes configuring a systems framework, of the identified file system platform, for collecting information of the plurality of disk assigned to the file systems platform. The method further includes equipping the file system platform and a monitoring system with learning or knowledge based engines to identify workload types for utilizing the file system platform and the named space to identify health of multiple platters of the plurality of disk assigned to the file systems platform. The method further includes calculating duplication data of sectors of the plurality of disks of the identified workload types, based on the sectors of disks.

According to another embodiment, a computer system for optimizing duplication of disk sector architecture in a heterogeneous cloud systems environment, is provided. The computer system includes one or more processors, one or more computer-readable memories, one or more computer-readable tangible storage devices and program instructions which are stored on at least one of the one or more storage devices for execution by at least one of the one or more processors via at least one of the one or more memories. The computer system includes program instructions to identify a file system platform and name space for tracking a plurality of disk, of the disk sector architecture, wherein plurality of disks are assigned to file systems of the file system platform. The computer system includes program instruction to configure a systems framework, of the identified file system platform, for collecting information of the plurality of disk assigned to the file systems platform. The computer system further includes program instructions equip the file system platform and a monitoring system with learning or knowledge based engines to identify workload types for utilizing the file system platform and the named space to identify health of multiple platters of the plurality of disk assigned to the file systems platform. The computer system further includes program instructions to calculate duplication data of sectors of the plurality of disks of the identified workload types, based on the sectors of disks.

According to yet another embodiment, a computer program product for optimizing duplication of disk sector architecture in a heterogeneous cloud systems environment, is provided. The computer program product includes one or more computer-readable tangible storage devices and program instructions stored on at least one of the one or more storage devices. The computer program product includes program instructions to identify a file system platform and name space for tracking a plurality of disk, of the disk sector architecture, wherein plurality of disks are assigned to file systems of the file system platform. The computer program product further includes program instructions to configure a systems framework, of the identified file system platform, for collecting information of the plurality of disk assigned to the file systems platform. The computer program product further includes program instructions equip the file system platform and a monitoring system with learning or knowledge based engines to identify workload types for utilizing the file system platform and the named space to identify health of multiple platters of the plurality of disk assigned to the file systems platform. The computer program product further includes program instructions to calculate duplication data of sectors of the plurality of disks of the identified workload types, based on the sectors of disks.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a block diagram of internal and external components of computers and servers depicted in FIG. 1 according to at least one embodiment;

FIG. 2 is a block diagram of an illustrative cloud computing environment including the computer system depicted in FIG. 1, in accordance with an embodiment of the present disclosure;

FIG. 3 is a block diagram of functional layers of the illustrative cloud computing environment of FIG. 7, in accordance with an embodiment of the present disclosure;

FIG. 4 is an alternative flowchart illustrating the steps carried out by a program for forming a systems framework or a message server to file system to identify the underlying disks associated with file system according to at least one embodiment;

FIG. 5 is an alternative flowchart illustrating the steps carried out by a program for forming a systems framework or a message server to file system to identify the underlying disks associated with file system according to at least one embodiment;

FIG. 6 is an alternative flowchart illustrating the steps carried out by a program for forming a systems framework or a message server to file system to identify the underlying disks associated with file system according to at least one embodiment;

FIG. 7 is an alternative flowchart illustrating the steps carried out by a program for forming a systems framework or a message server to file system to identify the underlying disks associated with file system according to at least one embodiment; and

FIG. 8 is an alternative flowchart illustrating the steps carried out by a program for forming a systems framework or a message server to file system to identify the underlying disks associated with file system according to at least one embodiment.

### DETAILED DESCRIPTION

Embodiments of the present invention provide an efficient file system algorithm in heterogeneous cloud environment, which typically comprises of mixed disk architectures such as a combination of longitudinal magnetic recording (LMR), perpendicular magnetic recording (PMR) and shingled magnetic recording (SMR) disk technologies. The invention facilitates file system/name space to keep track of the disk platter health, ATE effects faced by the particular disk technology, word load deployed etc. and selects appropriate disk sector for storing the master copy vs. deduplicated data. As a result of incorporating this algorithm, the cloud infrastructure is optimized in terms of performance and improves reliability, including, for instance, increased disk life span.

The present invention enables a framework using which the file system can collect the details such as disk_type, ATE_effect, PFA_effect (Predictive Failure Analysis), platter_health etc. for each individual disk assigned for a particular file system. It equips the file system with a learning engine that identifies the workload type (such as Write intensive, WORM etc.) for which the name space/file system is used for and a monitoring system to identify the health of multiple platters of each disk associated with the file system. Based on the above collected details {(disk_type, ATE_effect, PFA_effect, platter_health), (workload_type)} a decision of which disk sectors needs to be used for storing the master data and which disk sectors needs to be used for storing the duplicated data for each particular disk is calculated.

For example, assume if a disk is PMR disk and effect of ATE is large, where as other disk associated with the file system is SMR disk and has no effect of ATE. In this case the INNER partitions of the PMR disk and OUTER partitions of SMR disk are used for storing the master data. Also, assume if a disk is SMR disk and its OUTER platters for damaged or on bad shape, where as other disk associated with the file system is a PMR disk and its OUTER platters are in good health with reduced ATE. In this case the INNER partitions of the SMR disk and OUTER partitions of PMR disk are used for storing the master data. The proposed algorithm helps decide the sectors of each disk participating in the file system to be used for storing master, duplicated data which helps to achieve optimized performance and improved life expectancy. Provides Disk fabrication technology awareness, for disk sector selection to store master data and duplicated data, workload awareness related to application nature, for disk sector selection to store master data and duplicated data and, also, further provides platter/spindle health awareness, for disk sector selection to store master data and duplicated data.

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several embodiments of A policy engine or method for public cloud storage environments that takes into account the user's service level agreement and analyzes deduplicated and original files entries and performs a remapping operation as necessary to ensure that customers paying for a higher service level obtain higher speed access even though the file object forms a duplicate entry for a file originally stored on lower speed access.

In one general embodiment, a method is provided for ensuring compliance of service levels corresponding to file-system operations in a deduplicated, tiered storage system comprising storage devices of varying performance levels, each of the performance levels being associated with at least one service level. The method includes performing a deduplication remapping operation so that a data item corresponding to a higher service level, is stored as an original on a higher performance storage tier while duplicates of the data item corresponding to a lower service level exist in lower performance storage tier at least in part as pointers to the data item on the higher performance storage tier.

In another general embodiment, a computer program product includes a computer readable storage medium having program code embodied therewith. The program code is readable/executable by a processor to perform a deduplication remapping operation so that a data item corresponding to a higher service level, is stored as an original on a higher performance storage tier while duplicates of the data item corresponding to a lower service level exist in lower performance storage tier at least in part as pointers to the data item on the higher performance storage tier.

In yet another general embodiment, a system includes a processor and logic integrated with and/or executable by the processor, The logic is adapted to perform a deduplication remapping operation so that a data item corresponding to a higher service level, is stored as an original on a higher performance storage tier while duplicates of the data item corresponding to a lower service level exist in lower performance storage tier at least in part as pointers to the data item on the higher performance storage tier.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as “logic,” “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing and/or storage environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

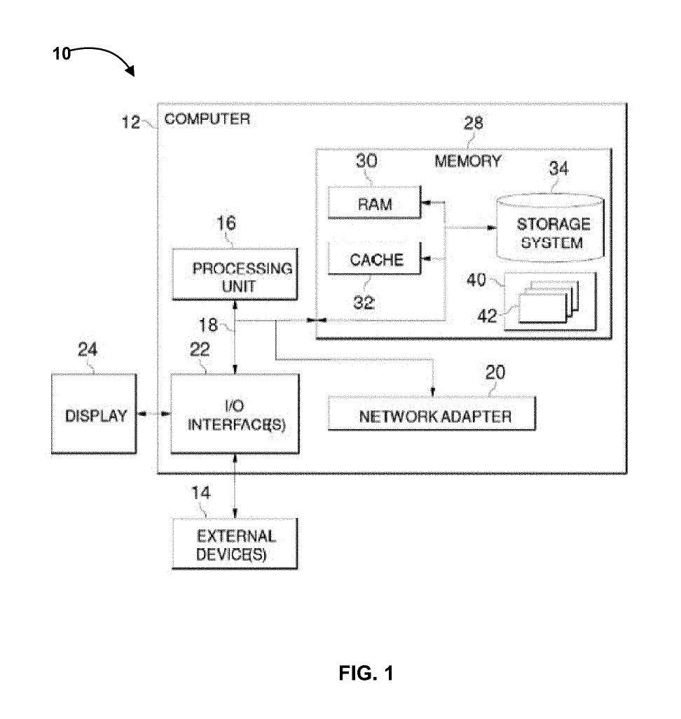

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

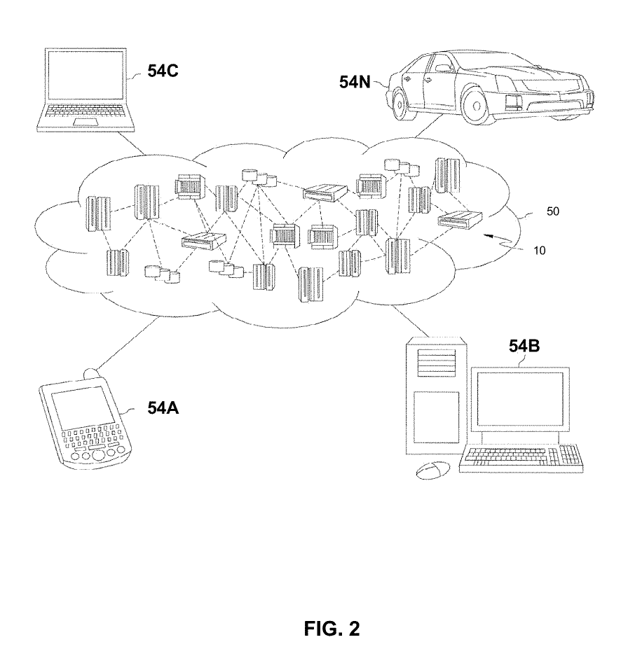

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

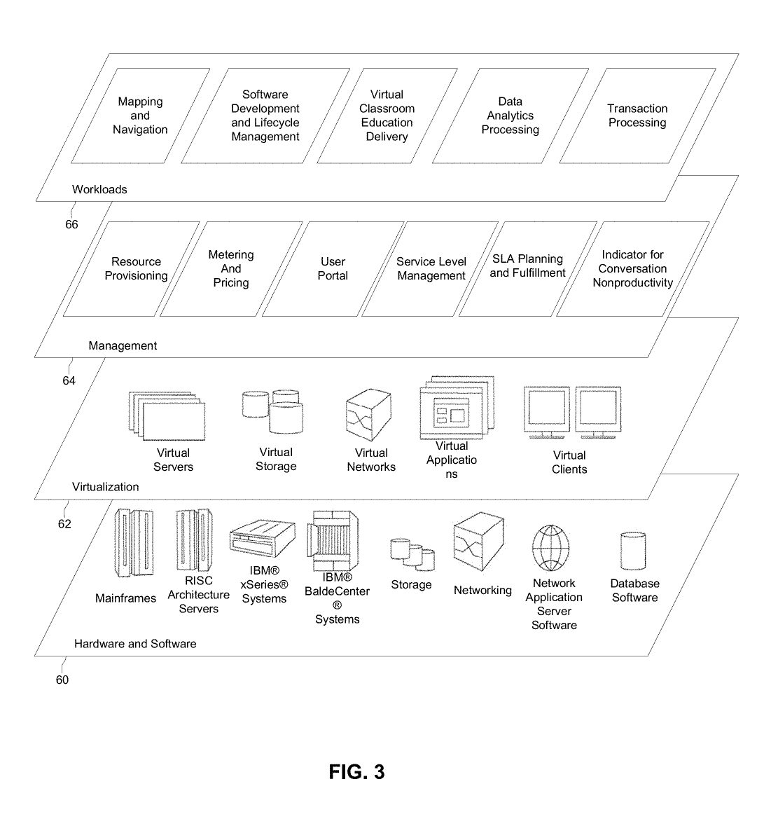

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. Service level management and/or SLA may include service level compliance functionality as described herein.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; service level compliance; etc.

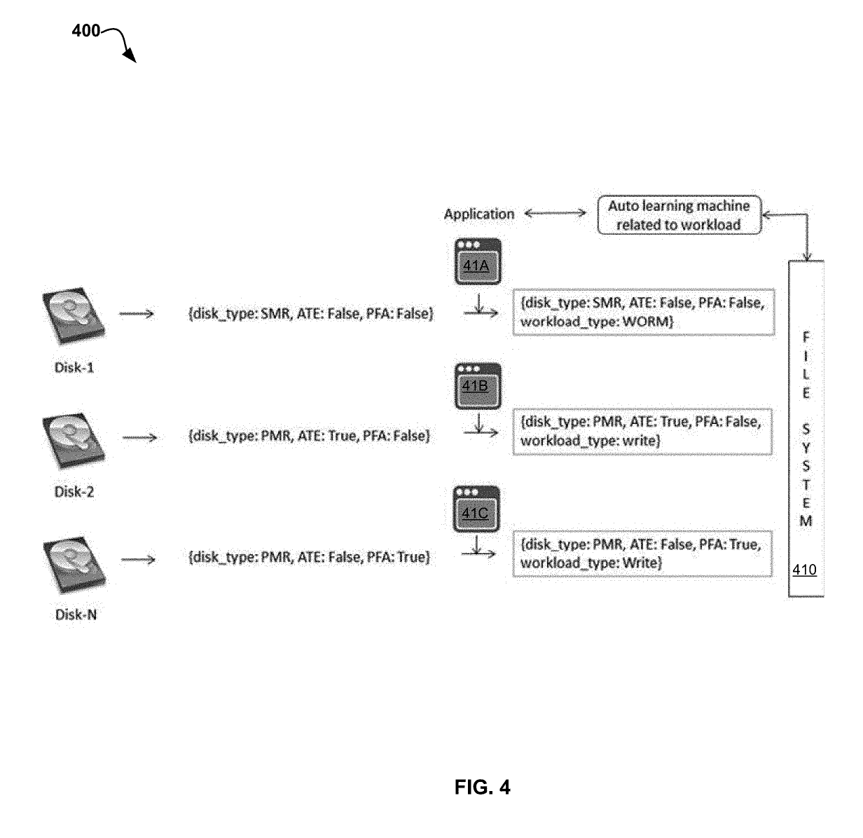

Referring now to FIG. 4, a heterogeneous cloud systems environment 400 for forming a systems framework or a message server to file system to identify the underlying disks associated with file system 410 of the heterogeneous cloud systems environment 400, according to embodiments. In the depicted environment, a systems framework or a message server is formed and transferred to the file system 410 to identify the underlying disks, Disk 1, Disk 2 . . . Disk N associated with the file system 410 and its parameters such as disk type, ATE effect, PFA (predictive failure analysis), platter structure etc. for each disk and form a data structure and applications 41A, 41B, 41C, as depicted, according to embodiments.

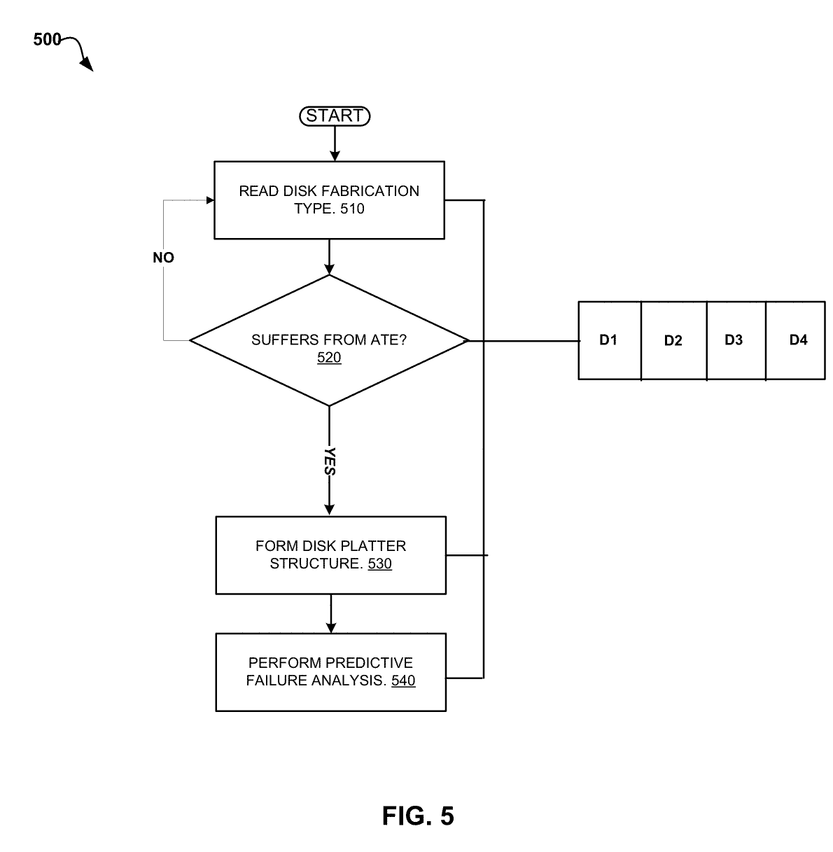

Referring now to FIG. 5, is a flow diagram 500 of the heterogeneous cloud systems environment 400 for forming a systems framework or a message server to file system to identify the underlying disks associated with file system 410 of the heterogeneous cloud systems environment 400. At step 510 a disk sector architecture of the heterogeneous cloud systems environment 400 reads disk fabrication within the heterogeneous cloud systems environment 400. At decision 520, the disk sector architecture determines whether it is suffering from ATE? If the disk sector architecture is suffering from ATE, then, at step 530 the disk sector architecture forms disk platter structure within the heterogeneous cloud systems environment 400. However, if the disk sector architecture does not suffer from ATE, then, at step 510, the disk platter structure reads disk fabrication type within the heterogeneous cloud systems environment 400. At step 540, the disk platter structure performs predictive failure analysis within the heterogeneous cloud systems environment 400, according to embodiments.

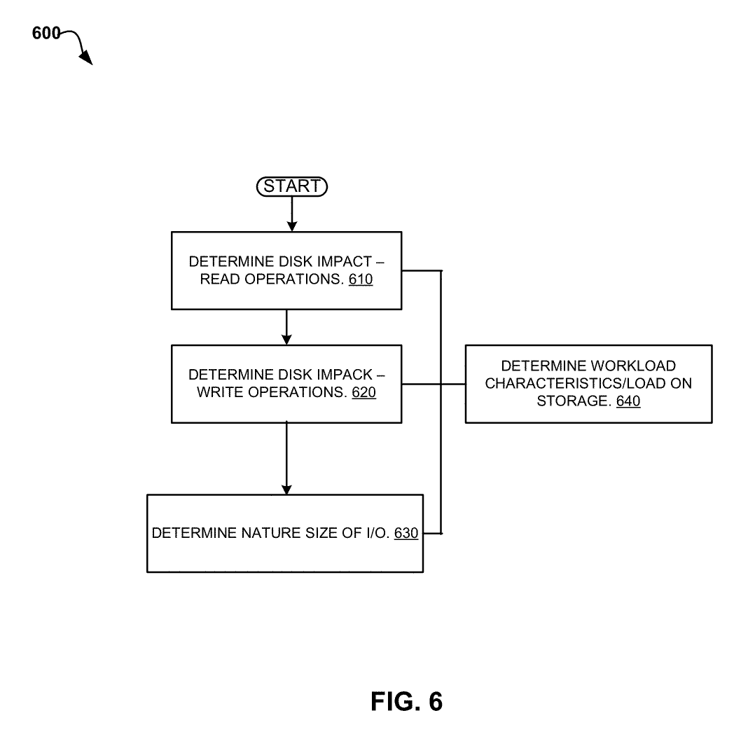

Referring now to FIG. 6, is alternative flow diagram 600 of the heterogeneous cloud systems environment 400 for forming a systems framework or a message server to file system to identify the underlying disks associated with file system 410 of the heterogeneous cloud systems environment 400. At step 610, the disk platter structure determines disk impact read operations. At step 620, the disk platter structure determines disk impact write operations. At step 630, the disk platter structure determines nature size of I/O of systems within of the heterogeneous cloud systems environment 400. At step 640, the disk platter structure determines workload characteristics of storage of the heterogeneous cloud systems environment 400, according to embodiments.

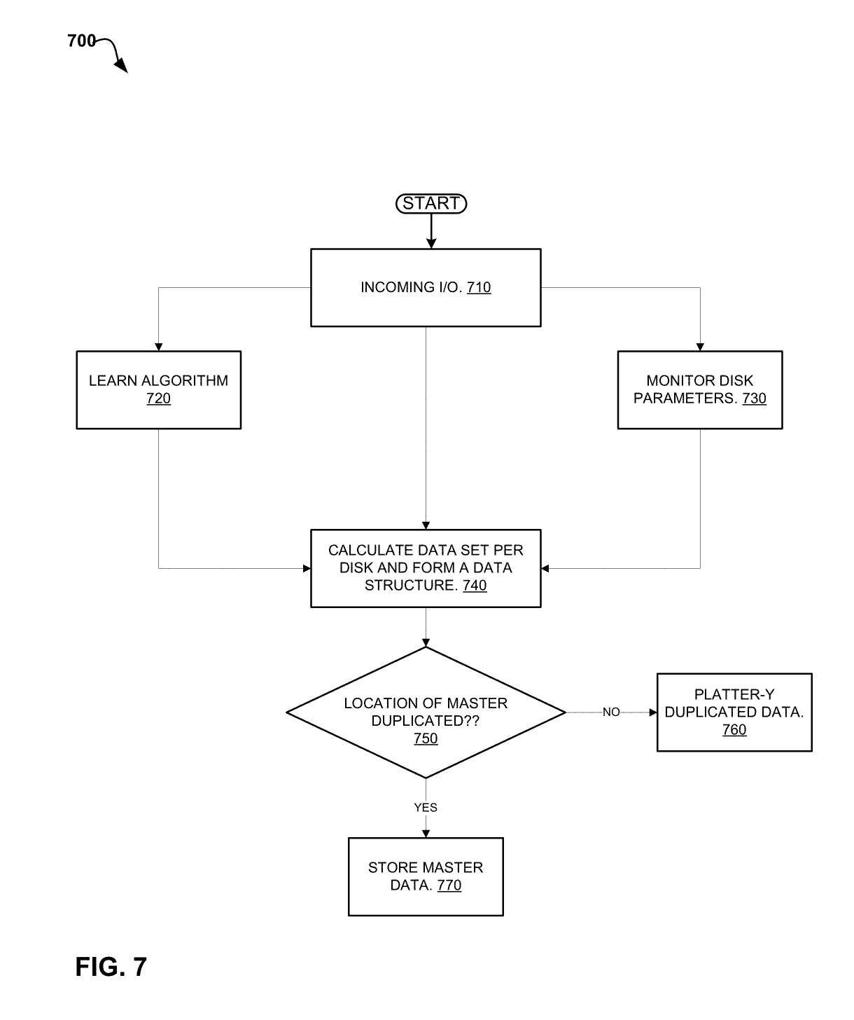

Referring now to FIG. 7, is alternative flow diagram 700 of the heterogeneous cloud systems environment 400 for forming a systems framework or a message server to file system to identify the underlying disks associated with file system 410 of the heterogeneous cloud systems environment 400. At step 710, the disk platter structure detects incoming I/O. At decision 720, the disk platter structure determines learning algorithms of the heterogeneous cloud systems environment 400. At step 720, the disk platter structure learn algorithms of the heterogeneous cloud systems environment 400. At step 730, the disk platter structure monitors disk parameter of the disk platter structure. At step 740, the disk platter structure calculates data set per disk form a data structure. At decision 750, location of mater duplication of the heterogeneous cloud systems environment 400 is determined by the disk platter structure. If the location is determined, then, at step 770, the disk platter structure store master data of the heterogeneous cloud systems environment 400, according to embodiments. However, if the location is not determined, then, at step 760, the platter duplicates data of the disk platter structure.

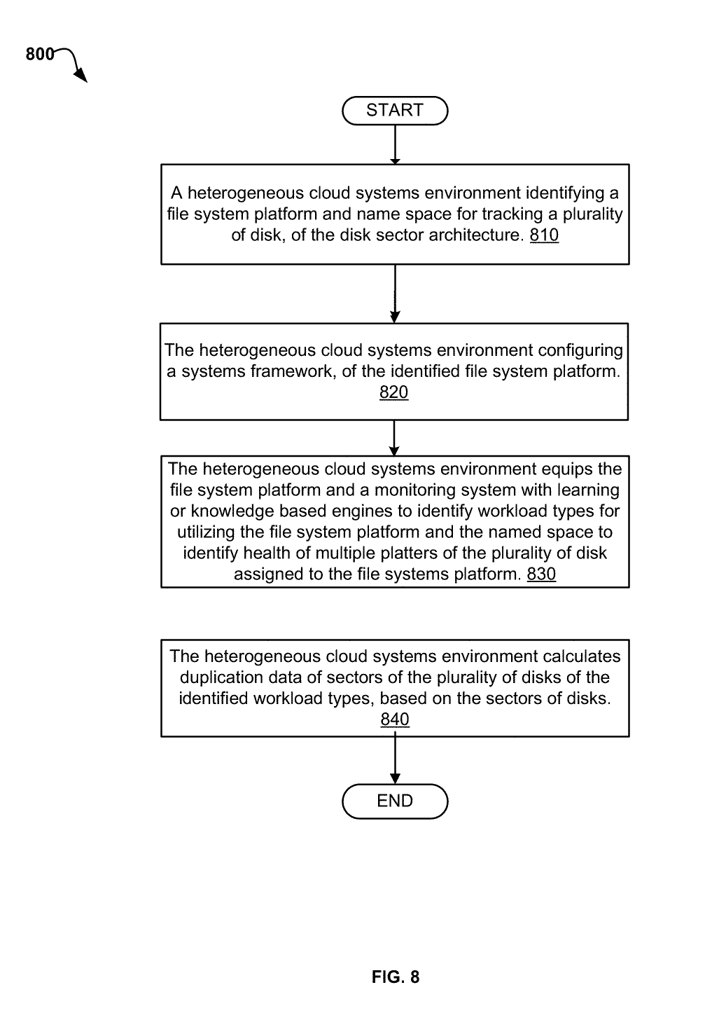

Referring now to FIG. 8, is alternative flow diagram 800 of the heterogeneous cloud systems environment 400 for forming a systems framework or a message server to file system to identify the underlying disks associated with file system 410 of the heterogeneous cloud systems environment 400. At step 810, the heterogeneous cloud systems environment 400 identifies a file system platform and name space for tracking a plurality of disk, of the disk sector architecture, wherein plurality of disks are assigned to file systems of the file system platform. At step 820 the heterogeneous cloud systems environment 400 configures a systems framework, of the identified file system platform, for collecting information of the plurality of disk assigned to the file systems platform. At step 830 the heterogeneous cloud systems environment 400 equips the file system platform and a monitoring system with learning or knowledge based engines to identify workload types for utilizing the file system platform and the named space to identify health of multiple platters of the plurality of disk assigned to the file systems platform. At step 840 the heterogeneous cloud systems environment 400 calculates duplication data of sectors of the plurality of disks of the identified workload types, based on the sectors of disks.

What is claimed is:

1. A method for optimizing duplication of disk sector architecture in a heterogeneous cloud systems environment, the method comprising:
identifying a file system platform and name space for tracking a plurality of disk, of the disk sector architecture, wherein plurality of disks are assigned to file systems of the file system platform;
configuring a systems framework, of the identified file system platform, for collecting information of the plurality of disk assigned to the file systems platform;
equipping the file system platform and a monitoring system with learning or knowledge based engines to identify workload types for utilizing the file system platform and the named space to identify health of multiple platters of the plurality of disk assigned to the file systems platform; and
calculating duplication data of sectors of the plurality of disks of the identified workload types, based on the sectors of disks.

2. The method according to claim 1, wherein the identified file system platform tracks at least one or more of disk health platter, adjacent track erasure, erasure coding, or speed variations between outer partitions or inner partitions of the plurality of disks, of the disk sector architecture of the heterogeneous cloud systems environment.

3. The method according to claim 2, wherein the at least one or more of disk health platter, adjacent track erasure, erasure coding, or speed variations between outer partitions or inner partitions of the plurality of disks are tracked to select disk sector for storing master copy or duplicated data of the plurality of disks.

4. The method of claim 2, wherein the heterogeneous cloud system environment includes a combination of at least one of longitudinal magnetic recording, perpendicular magnetic recording, and shingled magnetic recording.

5. The method according to claim 1, wherein heterogeneous cloud system environment is optimized due to performance and reliability based on the least one or more of disk health platter, adjacent track erasure, erasure coding, or speed variations between outer partitions or inner partitions of the plurality of disks.

6. The method according to claim 5, wherein the optimized performance and reliability of the heterogeneous cloud system environment increased disk life span of the plurality of disks.

7. The method according to claim 1, wherein the calculating duplication data of sectors of the plurality of disks is utilized for storing duplicated data of the master duplicated data based on disk fabrication technology, the identified workload types, and platter spindle health of the plurality of disks.

8. A computer system for optimizing duplication of disk sector architecture in a heterogeneous cloud systems environment, the method comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to identify a file system platform and name space for tracking a plurality of disk, of the disk sector architecture, wherein plurality of disks are assigned to file systems of the file system platform;
program instruction to configure a systems framework, of the identified file system platform, for collecting information of the plurality of disk assigned to the file systems platform;
program instructions equip the file system platform and a monitoring system with learning or knowledge based engines to identify workload types for utilizing the file system platform and the named space to identify health of multiple platters of the plurality of disk assigned to the file systems platform; and
program instructions to calculate duplication data of sectors of the plurality of disks of the identified workload types, based on the sectors of disks.

9. The computer system according to claim 8, wherein the identified file system platform tracks at least one or more of disk health platter, adjacent track erasure, erasure coding, or speed variations between outer partitions or inner partitions of the plurality of disks, of the disk sector architecture of the heterogeneous cloud systems environment.

10. The computer system according to claim 9, wherein the at least one or more of disk health platter, adjacent track erasure, erasure coding, or speed variations between outer partitions or inner partitions of the plurality of disks are tracked to select disk sector for storing master copy or duplicated data of the plurality of disks.

11. The computer system according to claim 9, wherein the heterogeneous cloud system environment includes a combination of at least one of longitudinal magnetic recording, perpendicular magnetic recording, and shingled magnetic recording.

12. The computer system according to claim 8, wherein heterogeneous cloud system environment is optimized due to performance and reliability based on the least one or more of disk health platter, adjacent track erasure, erasure coding, or speed variations between outer partitions or inner partitions of the plurality of disks.

13. The computer system according to claim 12, wherein the optimized performance and reliability of the heterogeneous cloud system environment increased disk life span of the plurality of disks.

14. The computer system according to claim 8, wherein the calculating duplication data of sectors of the plurality of disks is utilized for storing duplicated data of the master duplicated data based on disk fabrication technology, the identified workload types, and platter spindle health of the plurality of disks.

15. A computer program product for optimizing duplication of disk sector architecture in a heterogeneous cloud systems environment, the method comprising:
one or more computer-readable tangible storage devices and program instructions stored on at least one of the one or more storage devices, the program instructions comprising:
program instructions to identify a file system platform and name space for tracking a plurality of disk, of the disk sector architecture, wherein plurality of disks are assigned to file systems of the file system platform;
program instruction to configure a systems framework, of the identified file system platform, for collecting information of the plurality of disk assigned to the file systems platform;
program instructions equip the file system platform and a monitoring system with learning or knowledge based engines to identify workload types for utilizing the file system platform and the named space to identify health of multiple platters of the plurality of disk assigned to the file systems platform; and
program instructions to calculate duplication data of sectors of the plurality of disks of the identified workload types, based on the sectors of disks.

16. The computer program product according to claim 15, wherein the identified file system platform tracks at least one or more of disk health platter, adjacent track erasure, erasure coding, or speed variations between outer partitions or inner partitions of the plurality of disks, of the disk sector architecture of the heterogeneous cloud systems environment.

17. The computer program product according to claim 16, wherein the at least one or more of disk health platter, adjacent track erasure, erasure coding, or speed variations between outer partitions or inner partitions of the plurality of disks are tracked to select disk sector for storing master copy or duplicated data of the plurality of disks.

18. The computer program product according to claim 16, wherein the heterogeneous cloud system environment includes a combination of at least one of longitudinal magnetic recording, perpendicular magnetic recording, and shingled magnetic recording.

19. The computer program product according to claim 15, wherein heterogeneous cloud system environment is optimized due to performance and reliability based on the least one or more of disk health platter, adjacent track erasure, erasure coding, or speed variations between outer partitions or inner partitions of the plurality of disks.

20. The computer program product according to claim 19, wherein the optimized performance and reliability of the heterogeneous cloud system environment increased disk life span of the plurality of disks.
